(19) United States
(12) Patent Application Publication
(10) Pub. No.: US 2014/0069427 A1
(43) Pub. Date: Mar. 13, 2014

(54) HARNESS FOR BREATHING APPARATUS

(71) Applicants: James Farnaby, Newcastle-Upon-Tyne (Tyne and Wear) (GB); David Cheesman, Bedlington (Northumberland) (GB); Paul Townsend, Cramlington (Northumberland) (GB); Gordon Wrigley, Newcastle-Upon-Tyne (Tyne and Wear) (GB)

(72) Inventors: James Farnaby, Newcastle-Upon-Tyne (Tyne and Wear) (GB); David Cheesman, Bedlington (Northumberland) (GB); Paul Townsend, Cramlington (Northumberland) (GB); Gordon Wrigley, Newcastle-Upon-Tyne (Tyne and Wear) (GB)

(73) Assignee: DRAEGER SAFETY UK LIMITED, Blyth (Northumberland) (GB)

(21) Appl. No.: 14/005,681

(22) PCT Filed: Feb. 23, 2012
(86) PCT No.: PCT/GB12/50413

§ 371 Date: Nov. 22, 2013

(30) Foreign Application Priority Data
Mar. 18, 2011 (GB) 1104629.9

(51) Int. Cl. A62B 7/02

(52) U.S. Cl. CPC A62B 7/02
USPC 128/204.18

(57) ABSTRACT

There is disclosed a harness for breathing apparatus which is arranged to support a plurality of cylinders of breathable gas side-by-side and is arranged to be worn on the back of a wearer. The harness comprises upper and lower longitudinally spaced housings coupled together by a longitudinally extending back member. The upper and lower housings are arranged to retain upper and lower portions of each cylinder respectively.

The invention relates to a harness for breathing apparatus which is capable of supporting a plurality of cylinders of breathable gas side-by-side.

Self-contained breathing apparatus (SCBA) typically comprises a harness for supporting a single cylinder of breathable gas on the back of a user, a pressure reducer for reducing the pressure of the gas within the cylinder, and a fluid supply line for supplying the breathable gas to the user.

Whilst such an arrangement is suitable for many applications, the cylinder is usually relatively heavy and of a large diameter. The cylinder therefore usually projects from the user's back and may present a snagging risk when the user is required to crawl or climb through confined spaces. Further, the centre of gravity of the breathing apparatus is located behind and away from the user's back and therefore has a tendency to pull the user backwards, reducing their stability.

It may therefore be desirable to provide a lower-profile breathing apparatus set.

In a previously considered arrangement a plurality of small-diameter cylinders are located side-by-side in a fabric bag that can be worn on the back of a user. This may have the disadvantage that the breathing apparatus is not particularly stable or comfortable to wear.

It may therefore be desirable to provide an improved harness for breathing apparatus for carrying a number of cylinders of breathable gas side-by-side which provides increased comfort and stability.

In a broad aspect the invention relates to upper and lower housing portions of a harness for breathing apparatus which are arranged to retain upper and lower portions of a plurality of cylinders arranged side-by-side.

According to an aspect of the invention there is provided a harness for breathing apparatus, the harness arranged to support a plurality of cylinders of breathable gas side-by-side (or laterally spaced) and arranged to be worn on the back of a wearer, the harness comprising upper and lower longitudinally spaced housings coupled (or attached) together by a longitudinally extending back member, the upper and lower housings arranged to retain upper and lower portions of each cylinder respectively. The upper and lower housings may retain the cylinders in a predetermined, or fixed, relationship with respect to one another. This would prevent the cylinders from separating or from coming into contact with one another. The housings may keep the cylinders substantially parallel to one another. The upper and lower housings may be discrete components.

The upper housing may be arranged to retain the upper end of each cylinder. The lower housing may be arranged to retain the lower end of each cylinder. In such an arrangement the upper and lower housings would act as end caps or covers.

The upper housing may be curved or curvable in a direction towards the back of a wearer. The lower housing may be curved or curvable in a direction towards the back of a wearer. The curvature may be in a plane perpendicular to the user's back and/or the longitudinal direction of the harness. This would allow the harness to conform, or closely follow, the profile of a user. If the upper and/or lower housings are curvable, each housing may comprise a plurality of housing portions with a flexible joint in between, thus allowing the housings to be curved towards the user's back in a plane perpendicular to the longitudinal direction of the harness.

The upper housing may be rigid, or at least partially rigid. The lower housing may be rigid, or at least partially rigid.

The upper housing may be flexible in a plane substantially perpendicular to the longitudinal direction of the harness such that the upper housing is curvable towards the back of a wearer. Similarly, the lower housing may be flexible in a plane substantially perpendicular to the longitudinal direction of the harness such that the upper housing is curvable towards the back of a wearer.

The upper and/or lower housing may comprise a plastics material. The upper and/or lower housing may be an injection moulded component.

The back member may comprise, or may be fabric. The back member may be a fabric panel or a plurality of fabric panels.

The harness may further comprise a cover that can be moved between at least a closed configuration in which in use the cylinders are covered and an open configuration in which in use the cylinders are at least partially exposed. The cover may comprise a layer of fabric. The cover may be coupled or attached to the back member. The cover may be continuous with the back member.

The upper housing may be arranged to house breathing apparatus components. The lower housing may be arranged to house breathing apparatus components. The upper and/or lower housing may be arranged to house one or more breathing apparatus components selected from the group consisting of: a pressure reducer, a pressure transducer, a fluid manifold that is in fluid communication with the plurality of cylinders, electronic circuitry, and a pressure gauge. This would provide protection to the breathing apparatus components.

The harness may further comprise left and right shoulder straps. Each strap may be attached at an upper end to the upper housing and/or at a lower end to the lower housing. The harness may further comprise a waist belt. The waist belt may be attached to a plate which is attached to the back member. The lower ends of the left and right shoulder straps may be attached to the plate. The waist belt may be attached to the back member. The waist belt may be pivotally attached.

The harness may be arranged to support at least three, at least four or at least five cylinders side-by-side.

The invention also concerns a breathing apparatus set comprising: a harness in accordance with any statement herein; and a plurality of cylinders of breathable gas supported by the harness, wherein upper and lower portions of each cylinder is retained by the upper and lower housings respectively.

There may be at least three, at least four or at least five cylinders. The cylinders may have an outermost layer of carbon-fibre. The cylinders may have upper and lower cylinder portions in fluid communication through a fluid joint. The fluid joint may be flexible.

The cylinders may have a diameter of between 50-150 mm, between 50-100 mm, or between 75-100 mm, for example. The length of the cylinders may be between 500-1000 mm, between 600-900 mm, or between 700-800 mm, for example.

The invention may comprise any combination of the features and/or limitations referred to herein, except combinations of such features as are mutually exclusive.

Embodiments of the invention will now be described, by way of example, with reference to the accompanying drawings, in which:

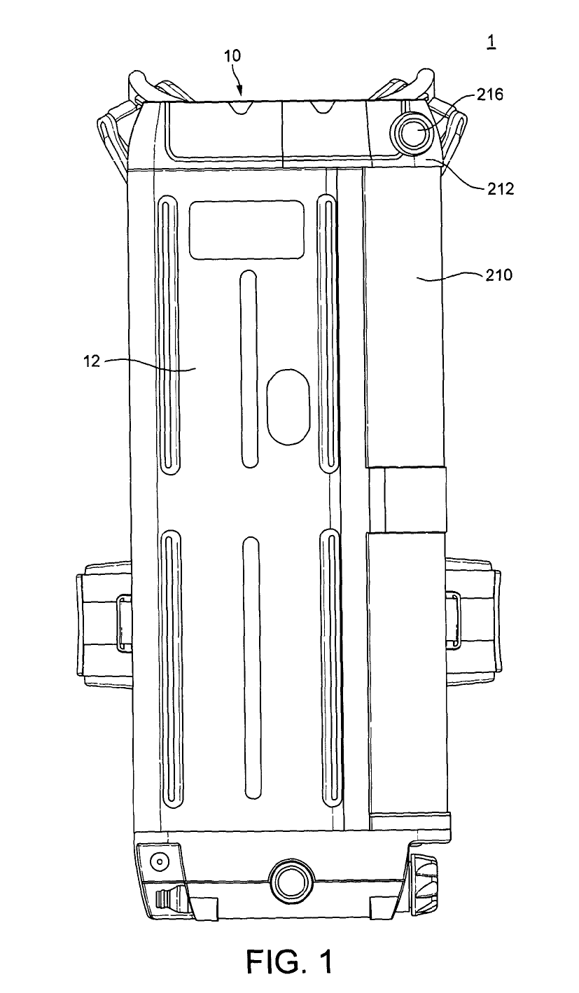

FIG. 1 schematically shows a front view of a breathing apparatus set;

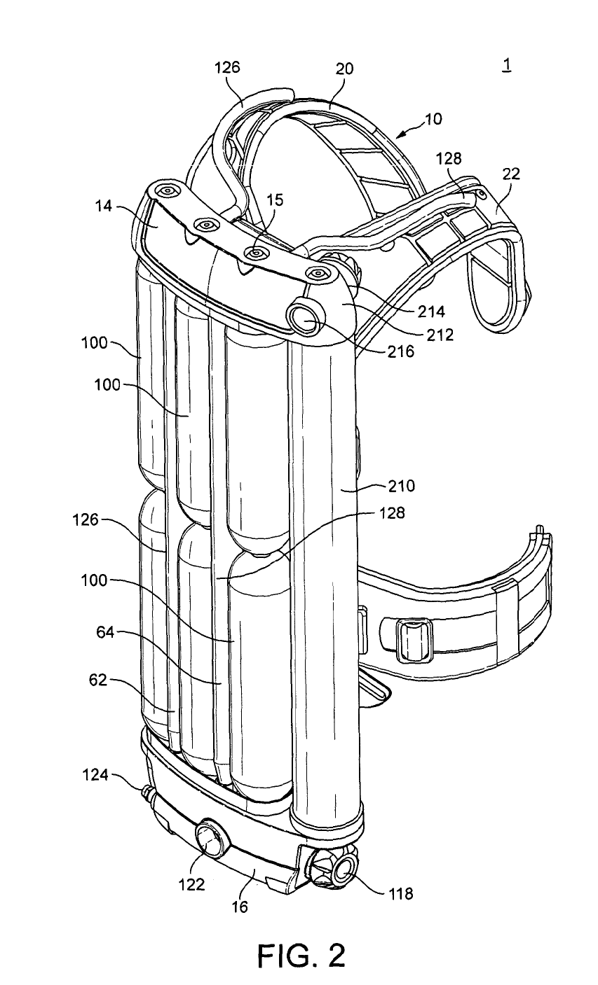

FIG. 2 schematically shows a perspective view of the breathing apparatus set of FIG. 1 with the cover removed;

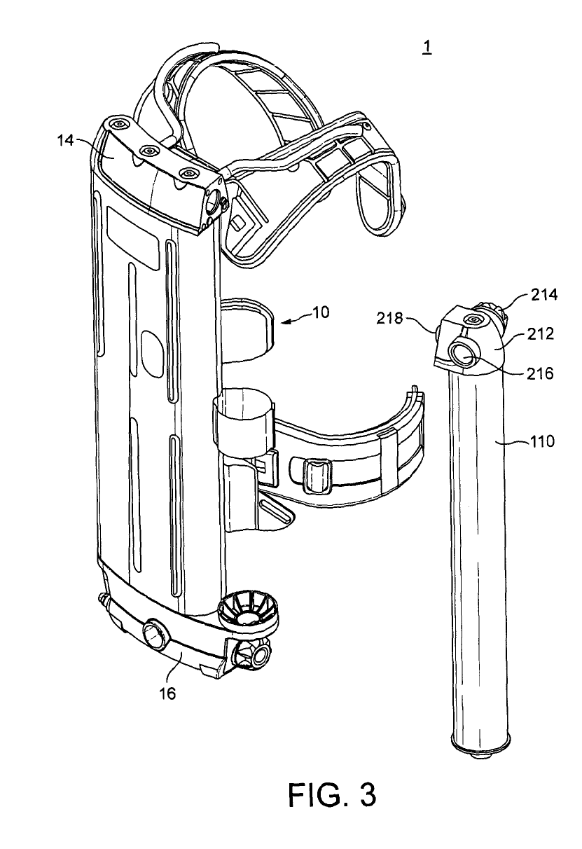

FIG. 3 schematically shows the breathing apparatus set of FIG. 2 with the auxiliary cylinder module removed;

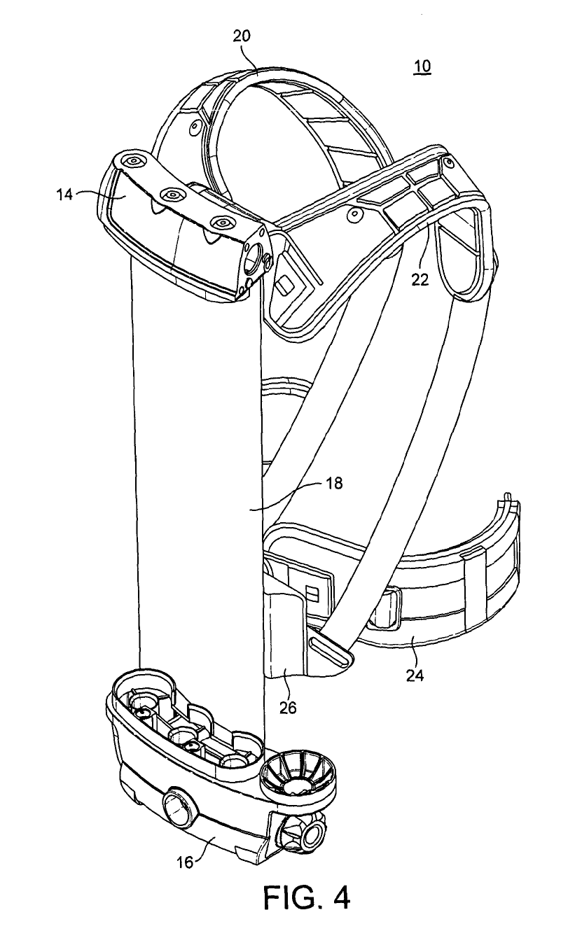

FIG. 4 schematically shows a perspective view of the harness of the breathing apparatus set of FIG. 1;

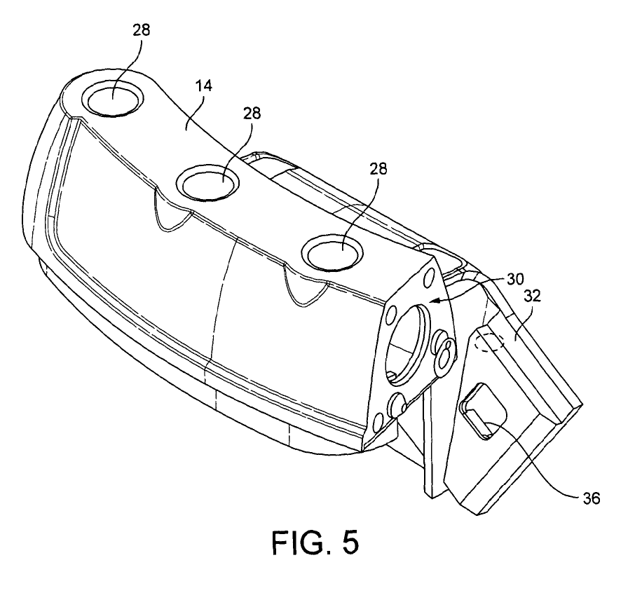

FIG. 5 schematically shows a perspective view of the upper housing of the harness;

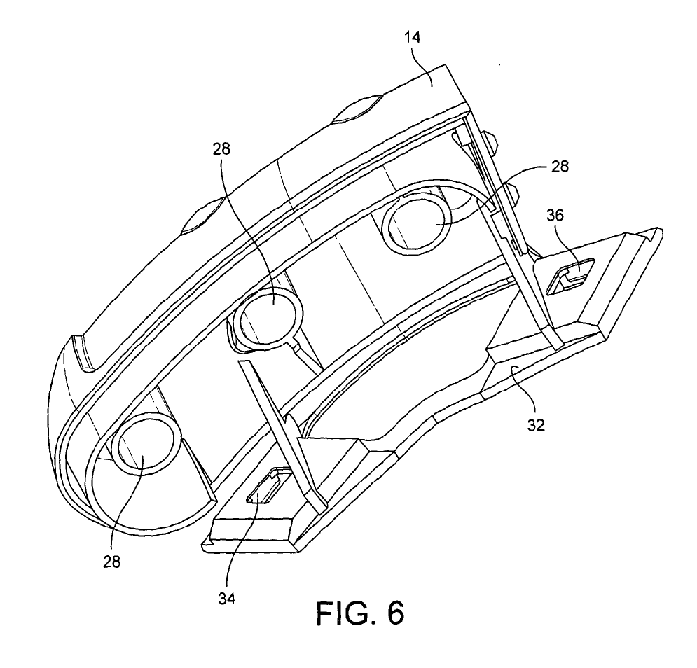

FIG. 6 schematically shows a perspective view from below of the upper housing;

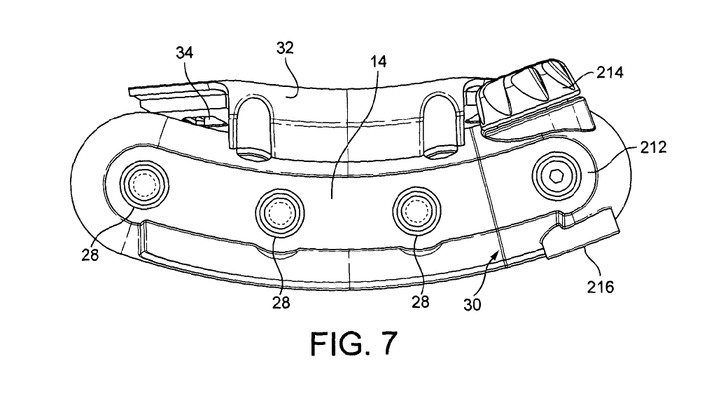

FIG. 7 schematically shows a top view of the upper housing;

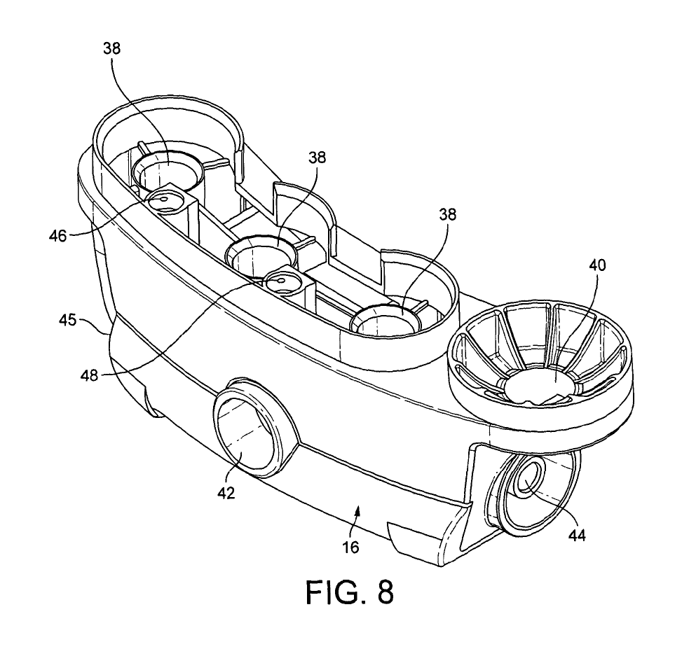

FIG. 8 schematically shows a perspective view of the lower housing of the harness;

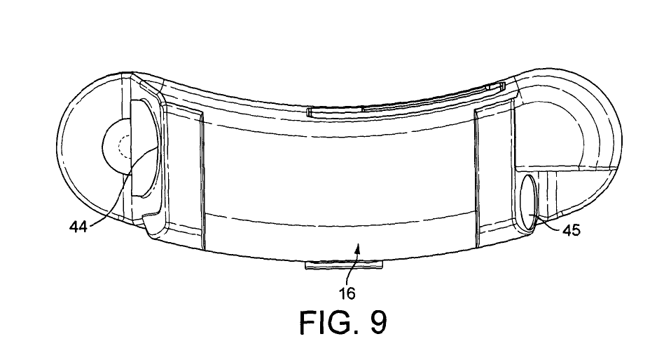

FIG. 9 schematically shows a bottom view of the lower housing;

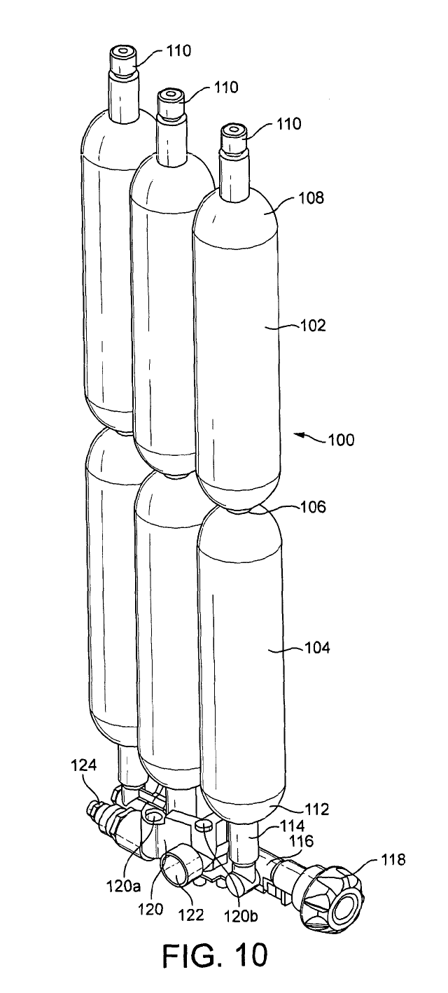

FIG. 10 schematically shows the cylinders of breathable gas and other breathing apparatus components; and

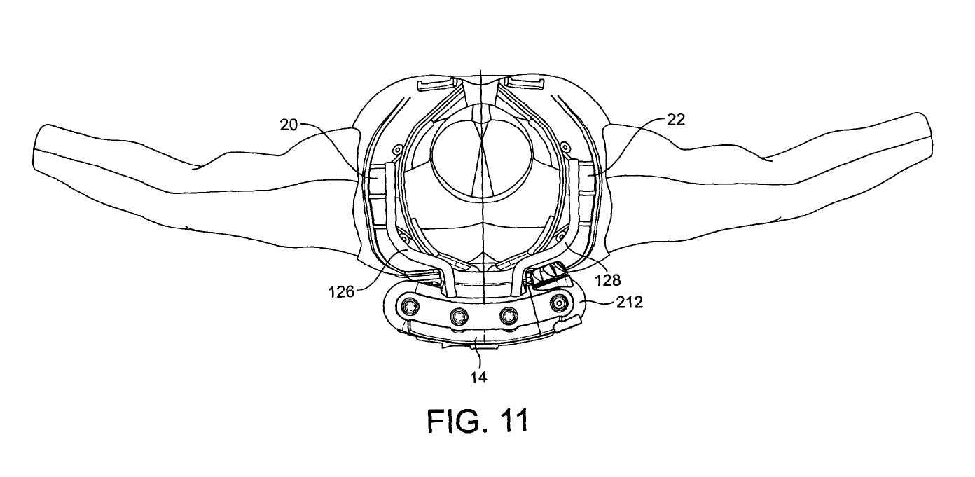

FIG. 11 schematically shows a plan view of the breathing apparatus in use.

FIGS. 1 and 2 show a breathing apparatus set 1 comprising a harness 10, a plurality of cylinders of breathable gas 100 and various breathing apparatus components. In this embodiment the harness 10 is capable of supporting three cylinders of breathable gas 100 side-by-side. However, it will be appreciated that the harness 10 may be capable of supporting any suitable number of cylinders of breathable gas. The harness 10 comprises a cover 12 in the form of a flexible fabric panel that can be moved between an open configuration in which the cylinders 100 are exposed and a closed configuration (shown in FIG. 1) in which the cylinders 100 are covered. For the purposes of clarity, the cover 12 is not shown in FIG. 2.

In addition to the main cylinders of breathable gas 100, the breathing apparatus set 1 also comprises an auxiliary cylinder module 210 that is detachably attached to the harness 10. The auxiliary cylinder module 210 comprises a cylinder of breathable gas, a top housing 212, a flow control valve 214, a pressure gauge 216 and a fluid connector 218. As can be seen in FIG. 3, if necessary, the auxiliary cylinder module 210 can be completely detached from the harness 1 and can be used for rescues purposes or the like.

FIG. 4, shows the harness 10 with the cover 12 removed and without the cylinders 100. The harness 10 is arranged to be worn on the back of a user and is generally longitudinally extending in the direction of the user's back. The harness 10 comprises an upper housing 14 and a lower housing 16 that is longitudinally spaced from the upper housing 14. The upper and lower housings 14, 16 extend in a direction across the user's back that is substantially perpendicular to the longitudinal direction. The upper and lower housings 14, 16 are attached together by a longitudinally extending back member 18 which in this embodiment is a fabric panel. It should be appreciated that in other embodiments the back member 18 may be a rigid panel, a flexible panel, or a series of rigid bars, for example. The back member 18 can be attached to the upper and lower housings 12, 14 by any suitable method such as by stitching or riveting, for example.

The upper housing 14 is arranged to retain the upper ends of each cylinder 100 and the lower housing 16 is arranged to retain the lower ends of each cylinder 100. The lower housing 16 also houses other breathing apparatus components, which will be described in detail below. When the cylinders are attached to and supported by the harness 10, this results in a substantially rigid assembly with the longitudinal rigidity provided by the cylinders, and the transverse rigidity provided by the upper and lower housings 14, 16.

The harness 10 also comprises left and right shoulder straps 20, 22 and a waist belt 24 that enables the harness to be comfortably worn by a user. The waist belt 24 is pivotally attached to a plate 26 which is attached to the back member 18. The left and right shoulder straps 20, 22 are each attached at an upper end to the top housing 14 and at a lower end to the plate 26. The length of the shoulder straps 20, 22 and the waist belt 24 can be adjusted for maximum user comfort.

With reference to FIGS. 5 and 6, the upper housing 14 is an integrally formed rigid component formed by injection moulding a plastics material. The upper housing 14 is generally transversely extending and is curved in a plane perpendicular to the longitudinal direction of the harness 10. In use, the upper housing 14 is therefore curved towards the user's back and therefore more closely conforms the profile of the user's back. The underside of the upper housing 14 comprises three laterally spaced cylinder retainer openings 28 within which a portion of a cylinder can be located. In this embodiment the openings 28 extend through the upper surface of the upper housing 14. In this particular embodiment the openings 28 are circular openings. An end of the upper housing 14 is provided with an attachment portion 30 to which the top housing 212 of the auxiliary cylinder module 210 can be attached. As shown in FIG. 7, the top housing 212 is shaped such that when it is attached to the upper housing 14 it forms an integrated curved profile. The upper housing 14 further comprises a shoulder strap support plate 32 that comprises left and right shoulder strap attachment parts 34, 36 to which the upper ends of the left and right shoulder straps 20, 22 can be attached.

With reference to FIGS. 8 and 9, the lower housing 16 is an integrally formed rigid component formed by injection moulding a plastics material. Like the upper housing 14, the lower housing is generally transversely extending and is curved in a plane perpendicular to the longitudinal direction of the harness 10. In use, the lower housing 16 is therefore curved towards the user's back and therefore more closely conforms to the profile of the user's back. In this embodiment, the curvature of the lower housing 16 is the same as the curvature of the upper housing 14. The upper side of the lower housing 16 comprises three laterally spaced cylinder retainer collars 38 within which a portion of a cylinder can be located. The lower housing 16 also comprises an auxiliary cylinder module dock 40 within which a lower end of the auxiliary cylinder module 210 can be located. The lower housing 16 defines a housing interior within which various breathing apparatus components can be located. In this embodiment the interior of the lower housing 16 is arranged to accommodate a pressure gauge, a pressure reducer, a flow control valve, a quick-fill connector, a fluid manifold and a pressure transducer. The lower housing 16 is therefore provided with a pressure gauge opening 42 through which the display of a pressure gauge can be viewed, a valve opening 44 through which a valve handle of a flow control valve can extend, a quick-fill connector opening 45 through which a quick-fill connector can extend, and two conduit openings 46, 48 through which flexible conduits can pass.

FIG. 10 shows the arrangement of the cylinders of breathable gas 100 and other breathing apparatus components that form part of the breathing apparatus set 1. There are three cylinders of breathable gas 100, each having an upper cylinder 102 in fluid communication with a lower cylinder 104 through a flexible fluid joint 106. Each cylinder 100 comprises an inner plastic liner that is blow moulded and overwrapped with a layer of Kevlar® which is subsequently overwrapped with a layer of carbon fibre. This produces a very strong, lightweight cylinder that is flexible about the fluid joint 106. The upper end 108 of each cylinder 100 is provided with an upper fluid connector 110 and the lower end 112 of each cylinder 100 is provided with a lower fluid connector 114. Each upper and lower fluid connector 110, 114 has a stop valve that prevents fluid from leaking through the connector when the connector is not attached to an appropriate fluid conduit. The lower fluid connector 114 of each cylinder 100 is attached to a fluid manifold 116 that fluidically connects all three of the cylinders 100. Since the upper fluid connector 110 of each cylinder 100 is not connected the stop valve is closed and breathable gas cannot exit through the upper fluid connector. The fluid manifold 116 is provided with a flow control valve 118 that can control the fluid flow through the manifold 116 and pressure reducer 120 that reduces the pressure of the breathable gas. A pressure gauge 122 is also provided that can measure the cylinder pressure and hence the amount of breathable gas remaining and a quick-fill connector 124 is provided for recharging the cylinders through the manifold 116.

Referring back to FIG. 2, when the breathing apparatus set 1 is assembled the three cylinders 100 are retained between the upper and lower housings 14, 16 with the upper end of each cylinder retained by the upper housing 14 and the lower end of each cylinder retained by the lower housing. Specifically, the upper connector 110 of each cylinder 100 is located within the cylinder retainer openings 28 provided by the upper housing 14 and the lower connector 114 of each cylinder 100 passes through the cylinder retainer collars 38 provided by the lower housing 16. The fluid manifold 116, the flow control valve 118, the pressure reducer 120, the pressure gauge 122 and the quick-fill connector 124 are all at least partially housed within, and protected by, the lower housing 16. The display of the pressure gauge 122 can be viewed through the pressure gauge opening 42, the handle of the flow control valve 118 extends through the valve opening 44 and the quick fill connector 124 extends through the quick-fill connector opening 45. In order to prevent the upper end of the cylinders 100 from being withdrawn from the upper housing 14, fixing caps 15 are provided that prevent, or at least inhibit, the withdrawal of the upper connectors 110 through the openings 28.

As shown in FIG. 10, the pressure reducer 120 comprises a high-pressure outlet 120a and a medium pressure outlet 120b. Within the interior of the lower housing 16, a high-pressure hose (not shown) connects the high-pressure outlet 120a to an electronic pressure transducer (not shown) that provides a digital output representative of the cylinder pressure. An electrical cable (not shown) is shrouded in an electrical conduit 126 that extends through one of the conduit openings 46 provided in the lower housing 16. The electrical conduit 126 longitudinally extends up the harness 10, passes through the upper housing 14 and extends to a position on the left shoulder strap 20. The electrical cables within the conduit 126 can be connected to an electronic display device so that the user can easily monitor the quantity of air within the cylinders. The electronic display device may also provide the functions of an ADSU (or PASS). A battery and other electronic components may be provided in the lower housing 16. Other electrical cables, such as a power cable, may extend within the electrical conduit. A medium-pressure air conduit 128 is connected to the medium-pressure outlet 120b of the reducer 120 and passes through the other conduit opening 48 provided in the lower housing 16. The medium-pressure conduit 128 also extends longitudinally up the harness, passes through the upper housing 14 and extends to a position on the right shoulder strap 22. The medium-pressure conduit 128 may be connected to a lung-demand valve for supplying breathable air from the cylinders to the user.

As shown in FIG. 1, in use, the fabric cover 12 is located over the cylinders 100 and provides protection to the outer carbon-fibre coating. The auxiliary cylinder module 210 is attached to the harness 10 with the top housing 212 attached to the attachment portion 30 of the upper housing 14 and the lower end located within the dock 40 provided by the lower housing 16.

The breathing apparatus set 1 is substantially rigid and the longitudinal rigidity is provided by the cylinders 100. A small amount of longitudinal bending can occur due to the flexible cylinder joints 106. The transverse rigidity is provided by the rigid upper and lower housings 14, 16. The upper and lower housings 14, 16 also keep the cylinders 100 substantially parallel to one another and in a fixed or predetermined relationship. The housings 14, 16 also prevent the cylinders from coming into contact with one another which could potentially damage them. Also, as can be seen from FIG. 11, the curved profile of the upper and lower housings 14, 16 ensure that the harness 10 fits snugly to the user's body, in particular the user's shoulders and waist. This may reduce the risk of snagging and can result in the centre of gravity of the breathing apparatus set being closer to the user's body.

Although it has been described that the upper and lower housings 14, 16 are entirely rigid, the upper and lower housings 14, 16 could comprise a plurality of rigid sections with a flexible joint therebetween. This would allow the upper and lower housings 14, 16 to be flexible in a plane perpendicular to the longitudinal direction so that the upper and/or lower housings could be curved to adopt, or follow, the profile of the user's back. In such an arrangement the upper and lower housings 14, 16 would allow limited movement between the cylinders 100, but would prevent the cylinders from completely separating or from coming into contact with one another. The housings 14, 16 would also keep the cylinders substantially parallel to one another.

1-20. (canceled)

21. A breathing apparatus set comprising:
a harness comprising:
upper and lower longitudinally spaced rigid housings curved in a direction towards the back of a wearer and attached together by a longitudinally extending back member; wherein the upper and lower housings are each provided with one or more recesses;
left and right shoulder straps each attached at an upper end to the upper housing and at a lower end to the lower housing; and
a waist belt;
at least three cylinders of breathable gas supported by the harness and located side-by-side, the cylinders having their upper portions located within the at least one recess in the upper housing and their lower portions located within the at least one recess in the lower housing;
a fluid manifold in fluidic communication with the at least three cylinders and located within the lower housing; and
a pressure reducer located within the lower housing for reducing the pressure of the breathable gas within the at least three cylinders.

22. A harness for breathing apparatus, the harness arranged to support a plurality of cylinders of breathable gas side-by-side and arranged to be worn on the back of a wearer, the harness comprising upper and lower longitudinally spaced housings coupled together by a longitudinally extending back member, the upper and lower housings arranged to retain upper and lower portions of each cylinder respectively.

23. A harness according to claim 22, wherein the upper housing is arranged to retain the upper end of each cylinder and/or wherein the lower housing is arranged to retain the lower end of each cylinder.

24. A harness according to claim 22, wherein the upper housing and/or the lower housing is curved or curvable in a direction towards the back of a wearer.

25. A harness according to claim 22, wherein the upper housing and/or the lower housing is at least partially rigid.

26. A harness according to claim 22, wherein the upper and/or lower housing is flexible in a plane substantially perpendicular to the longitudinal direction of the harness such that the upper and/or lower housing is curvable towards the back of a wearer.

27. A harness according to claim 22, wherein the upper and/or lower housing comprises a plastics material.

28. A harness according to claim 22, wherein the back member comprises a layer of fabric.

29. A harness according to claim 22, further comprising a cover that can be moved between at least a closed configuration in which in use the cylinders are covered and an open configuration in which in use the cylinders are at least partially exposed.

30. A harness according to claim 22, wherein the cover comprises a layer of fabric.

31. A harness according to claim 29, wherein the cover is coupled to the back member.

32. A harness according to claim 22, wherein the upper and/or lower housing is arranged to house breathing apparatus components.

33. A harness according to claim 32, wherein the upper and/or lower housing is arranged to house one or more breathing apparatus components selected from the group consisting of: a pressure reducer, a pressure transducer, a fluid manifold that is in fluid communication with the plurality of cylinders, electronic circuitry, and a pressure gauge.

34. A harness according to claim 22, further comprising left and right shoulder straps.

35. A harness according to claim 34, wherein each strap is attached at an upper end to the upper housing and/or at a lower end to the lower housing.

36. A harness according to claim 22, further comprising a waist belt.

37. A harness according to claim 36, wherein the waist belt is attached to the back member.

38. A harness according to claim 36, wherein the waist belt is pivotally attached.

39. A harness according to claim 22, wherein the harness is arranged to support at least three, at least four or at least five cylinders side-by-side.

40. A breathing apparatus set comprising:
a harness in accordance with claim 22; and
a plurality of cylinders of breathable gas supported by the harness, wherein upper and lower portions of each cylinder are retained by the upper and lower housings respectively.
